(19) United States
(12) Patent Application Publication
(10) Pub. No.: US 2007/0201813 A1
(43) Pub. Date: Aug. 30, 2007

(54) VIDEO REPRODUCING APPARATUS AND VIDEO REPRODUCING METHOD

(75) Inventor: Atsushi ONODA, Fussa-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/676,899

(22) Filed: Feb. 20, 2007

(30) Foreign Application Priority Data
Feb. 27, 2006 (JP) 2006-050843

(51) Int. Cl. H04N 5/91

(52) U.S. Cl. 386/46

(57) ABSTRACT

A video reproducing apparatus includes, a video decoding unit that decodes the input video data, determines, on the basis of image management information included in the video data, whether or not the video data is video data to which a film grain is to be added, and adds, when the video data is video data to which the film grain is to be added, the film grain to the video data to be decoded, a noise reduction unit that reduces noises of the decoded video data, and a noise reduction control unit that sets off the noise reduction function of the noise reduction unit when it is determined that the video data is video data to which the film grain is to be added.

### CROSS-REFERENCE TO RELATED APPLICATIONS

This application claims the benefit of priority of Japanese Patent Application No. 2006-50843, filed Feb. 27, 2006, the entire contents of which are incorporated herein by reference.

### BACKGROUND

1. Field

The present invention relates to a video reproducing apparatus and a video reproducing method. Particularly, the present invention relates to a video reproducing apparatus having a noise reduction function of a video image and a video reproducing method.

2. Description of the Related Art

Currently, a large amount of video information is provided as digital video data that is digitized on the basis of MPEG standards and H.264 standard. Further, there are various providing systems of the digital video data to users. For example, the digital video data is variously provided, e.g., with recording media such as a DVD, via telecommunication lines such as the Internet, via a digital satellite broadcasting and a terrestrial digital broadcasting, and via wiring systems such as a CATV.

The digital video data reproduction apparatuses, e.g., a video reproducing apparatus is similarly varied, and there are various video reproducing apparatuses including a DVD player, a TV receiver apparatus, a personal computer, a game machine, and a mobile phone.

In general, the video reproducing apparatuses have a noise reduction function that reduces noise components included in video data and provide a video image with high quality.

However, the “video image with high quality” indicating as a simple description actually has criteria varied depending on “preferences” of users. Further, the criteria for the “high quality” are varied depending on video content (content). Therefore, even the uniform setting of characteristics of the noise reduction function, e.g., characteristics of a noise reduction filter does not necessarily satisfy all users.

Then, a technology of switching the characteristics of the noise reduction function depending on the type of video content is proposed.

For example, with a technology disclosed in JP-A 11-331777, the type of video content, e.g., a film mode (video mode) or a camera mode (video camera mode) is extracted from management information recorded to an optical disk and, if the type of video content is the film mode (video mode), the characteristics of the noise reduction filter are set to be relatively low, thereby making the quality of an original image effective.

As one of technologies for satisfying the “preferences” of the users to the video data, a so-called FGT (Film Grain Technology) is recently developed.

Unlikely a video image shot by a video camera, a movie film has fine grains on the video image thereof due to the unevenness of a photosensitive element (silver halide grain). Patterns of the grains are varied every frame and the grains therefore changeably move like dancing. The grain of the movie film is referred to as a film grain. The effect of the film grain produces the atmosphere unique to the movie film different from the film of the video camera. Accordingly, special importance has been conventionally placed on the film grain.

However, image processing with a high compression rate of MPEG or the like in recent years tends to remove fine portions of the film grain by the noise reduction. As a result, the texture of the movie cannot be given.

Then, the above-mentioned FGT is developed as a technology for retaining the characteristics of the film grain while keeping a high compression rate. With the FGT, the amount of film grain, color, and strength included in the video material are detected at the encoding timing and the encoded data is independently stored. At the reproducing timing (decoding timing), the film grain is appropriately generated from the stored data and the generated film gain is added to the video data.

As mentioned above, the current video reproducing apparatus generally has the noise reduction function. Therefore, even if the FGT adds the film grain to the video image, there is a problem that the noise reduction function reduces even the film grain and the effect of the film grain are thus suppressed.

### SUMMARY OF THE INVENTION

The present invention is devised in consideration of the above circumstances and it is an object of the present invention to provide a video reproducing apparatus and a video reproducing method that take advantage of the film grain added by the FGT and selectively control the noise reduction function in accordance with preferences of users.

In order to solve the above problem, according to one aspect of the present invention, a video reproducing apparatus comprises: a video decoding unit that decodes the input video data, determines, on the basis of image management information included in the video data, whether or not the video data is video data to which a film grain is to be added, and adds, when the video data is video data to which the film grain is to be added, the film grain to the video data to be decoded; a noise reduction unit that reduces noises of the decoded video data; and noise reduction control unit that sets off the noise reduction function of the noise reduction unit when it is determined that the video data is video data to which the film grain is to be added.

Further, in order to solve the above problem, according to another aspect of the present invention, a video reproducing method comprises the steps of: decoding the input video data, determining, on the basis of image management information included in the video data, whether or not the video data is video data to which a film grain is to be added, and adding, when the video data is video data to which the film grain is to be added, the film grain to the video data to be decoded; reducing noises of the decoded video data; and setting off the noise reduction function when it is determined that the video data is video data to which the film grain is to be added.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIGS. 1A to 1D are diagrams showing examples of the appearance of a video reproducing apparatus according to embodiments of the present invention;

FIG. 2 is a diagram showing an example of the system structure of a video reproducing apparatus according to the embodiments of the present invention;

FIG. 3 is a flowchart showing of an example of a video reproducing method according to an embodiment of the present invention;

FIG. 4 is a diagram schematically illustrating content of image management information of video data to which the FGT is applied;

FIG. 5 is a flowchart of the details showing an example of FGT determination processing with a video reproducing method according to the present invention;

FIG. 6 is a flowchart of the details showing an example of noise reduction control processing with the video reproducing method according to the embodiment of the present invention; and

FIG. 7 is a diagram schematically showing a selecting method of a DNR mode by a user.

### DETAILED DESCRIPTION

Hereinbelow, a description will be given of a video reproducing apparatus and a video reproducing method according to embodiments of the present invention with reference to the drawings.

### (1) Structure of Video Reproducing Apparatus

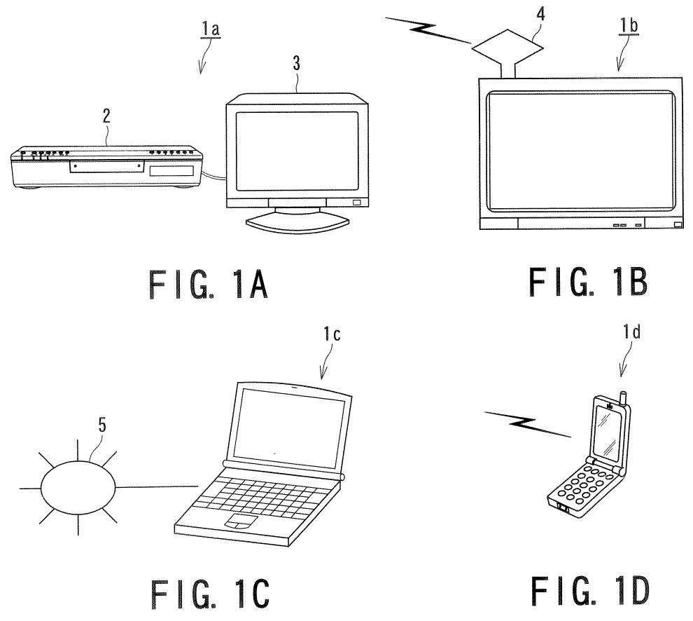

FIG. 1A to 1D are diagrams showing examples of the appearance of a video reproducing apparatus 1 according to the embodiments of the present invention. The video reproducing apparatus 1 according to the present invention inputs digital video data encoded on the basis of MPEG standards or H. 264 standard, and decodes and reproduces the data, and can be variously modified.

For example, referring to FIG. 1A, a video reproducing apparatus 1a (according to the first embodiment) can comprise a recording-medium reproducing device 2 that reproduces various recording media such as an optical disk and a hard disk and a video display unit 3.

Further, referring to FIG. 1B, a video reproducing apparatus 1b (according to the second embodiment) can comprise a TV receiver apparatus that can receive signals via digital satellite broadcasting, terrestrial digital broadcasting, or CATV.

Furthermore, referring to FIG. 1C, a video reproducing apparatus 1c (according to the third embodiment) can comprise a personal computer connected to a telecommunication circuit 5 such as the Internet or LAN. In this case, the telecommunication circuit 5 may be wired or wireless.

In addition, referring to FIG. 1D, a video reproducing apparatus id can comprise a mobile information processing device such as a mobile phone.

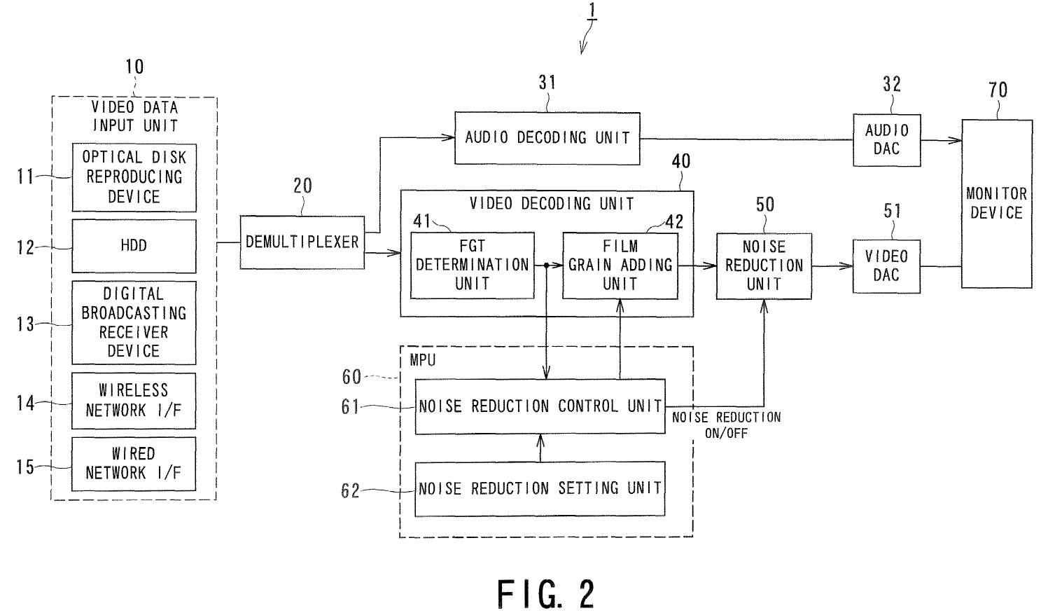

FIG. 2 is a diagram showing an example of the system structure of the video reproducing apparatus 1 according to the embodiments.

The video reproducing apparatus 1 comprises: video data input unit 10 that inputs digital video data on the basis of MPEG standards or H.264 standard; a demultiplexer 20 that demultiplexes the input digital video data into audio data and video data; audio decoding unit 31 that decodes the demultiplexed audio data; and an audio DAC 32 that converts the decoded audio data into an analog audio signal.

Further, the video reproducing apparatus 1 comprises: video decoding unit 40 that decodes the demultiplexed video data; noise reduction unit 50 that reduces noises included in the decoded video data; and a video DAC 51 that converts the video data into an analog video signal.

The video decoding unit 40 decodes the video data demultiplexed by the demultiplexer 20 and performs FGT determination processing and film grain addition processing (both of them will be described later). The FGT determination processing is performed by an FGT determination unit 41, and the film grain addition processing is performed by a film gain adding unit 42.

Further, the video reproducing apparatus 1 comprises an MPU 60 that entirely controls the video reproducing apparatus 1, sets the noise reduction (by noise reduction settingl unit 62), and controls the noise reduction (by noise reduction control unit 61).

Herein, the video data input unit 10 includes various units that can externally input the video data, and can variously be modified. For example, an optical disk reproducing device 11 that reproduces an optical disk such as a conventional DVD or an HD DVD is included in the video data input unit 10 according to the embodiments.

Similarly, an HDD 12 that records and reproduces the video data is included in the video data input unit 10 according to the embodiments.

A digital broadcasting receiver device 13 that receives terrestrial digital broadcasting and digital satellite broadcasting is also included in the video data input unit 10 according to the embodiments.

Further, a wireless network interface 14 and a wired network interface 15 are included in the video data input unit 10. A wireless network includes, e.g., a wireless LAN, Bluetooth (registered trademark), UWB (Ultra Wide Band), and a public wireless communication line such as a mobile phone line. In addition, a wired network line includes a wired LAN, Internet, and CATV network.

A video display unit 3 outputs the audio signal converted into the analog signal and displays a video signal. Alternatively, the video display unit 3 may include the audio DAC 32 and a video DAC 51. Further, alternatively, the video display unit 3 may be provided independently of the video reproducing apparatus 1 (the video reproducing apparatus 1 may not include the video display unit 3).

### (2) Operation (Video Reproducing Method)

A description will be given of the operation of the video reproducing apparatus 1 with the above structure, in particular, the operation for reproducing the video data with the FGT.

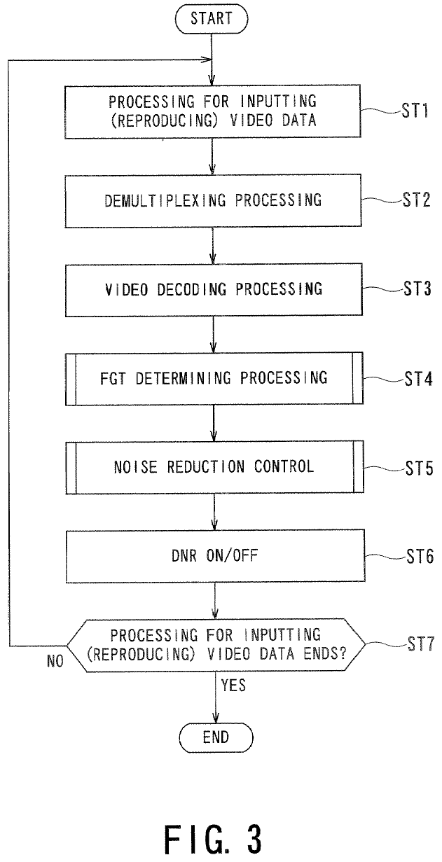

FIG. 3 is a flowchart showing the whole flow of one example of the operation of the video reproducing apparatus 1 in the processing for reproducing the video data with the FGT.

First, in step ST1, processing for inputting the video data is performed. The input processing is executed by the video data input unit 10.

Subsequently, in step ST2, demultiplexing processing is performed, thereby demultiplexing the data into audio data and video data. This processing is executed by the demultiplexer 20.

The demultiplexed video data is data encoded (compressed, etc.) on the basis of a predetermined MPEG standard or H.264 standard. Then, in step ST3, the decoding processing is performed, thereby restoring pre-encoded image data.

Further, the video reproducing apparatus 1 according to the embodiments performs the FGT determination processing (in step ST4) and noise reduction control (in step ST5). The processing will be described in detail.

Recently, a technology, i.e., so-called FGT is applied to the video data.

As mentioned above, the movie film has fine gains on the video image thereof due to the unevenness of a photosensitive element (silver halide grain), unlike the video image shot by the video camera. The effect of the grains gives the atmosphere unique to the movie, unlike the video camera. The grain unique to the movie film is called a film grain, and a movie fan and a film producer conventionally regard the film grain as important.

Meanwhile, in recent image processing with a high compression rate of MPEG, etc., the fine portions of the film grain trend to be removed by the noise reduction. As a consequence, the texture of the movie cannot be presented.

Then, the above-mentioned FGT is developed as a technology for keeping the characteristics of the film grain while retaining a high compression rate. With the FGT, the amount of the film grain, the color, and the strength included in the video material are detected at the encoding time, and are independently stored as data. Further, the film grain is properly generated from the data at the reproducing time (decoding time) and is added to the video data.

The FGT is not applied to all video data but is applied to the video data based on a part of standards. Therefore, it is necessary to determine whether or not the FGT is applied to the video data to be reproduced.

In general, the video data includes image data indicating an image every frame and image management information indicating the property of the image data. Then, it can be determined, by allowing the image management information to include information indicating whether or not the FGT is applied, whether or not the FGT is applied to the video data to be reproduced.

Currently, there is ITU-T H.264 standard as a video data standard to which the FGT is applied. The H.264 standard can be called MPEG4 AVC. Further, the two names of the H.264 standard and MPEG4 AVC can be called “H.264/AVC” standard.

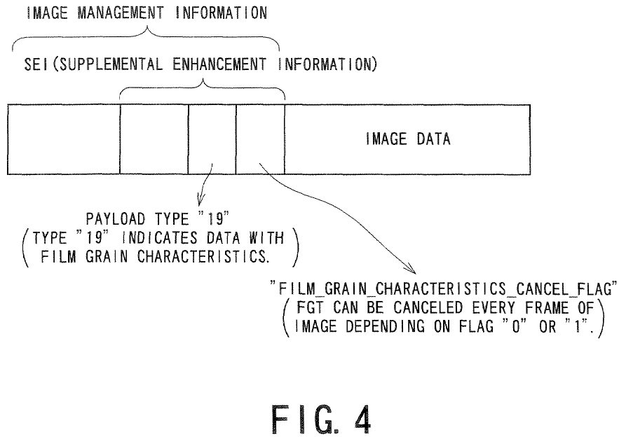

FIG. 4 is a diagram schematically showing one example of the structure of the video data based on the H.264/AVC standard to which the FGT is applied. The video data is mainly classified into the image management information and the image data.

The image management information includes information on the type of standards of the video data (e.g., H. 264/AVC standard, MPEG2, and MPEG4).

Further, in the case of the H.264/AVC standard, the image management information includes a message called SEI (Supplemental Enhancement Information).

In the case of the H.264/AVC standard, when data called “Payload Type” included in the SEI message indicates “19”, it is prescribed that the FGT is applied to the video data.

Further, the SEI message includes a flag called “film_grain_characteristics_cancel_flag” (hereinafter, simply referred to as an FGT cancel flag). The FGT is applied to the entire series of image data (e.g., the entire movie). Even if the film grain is added, the film grain is not to be added to a specific portion of the image data. The FGT cancel flag is used in this case and it can be controlled whether or not the film grain is added on the one frame unit of the image.

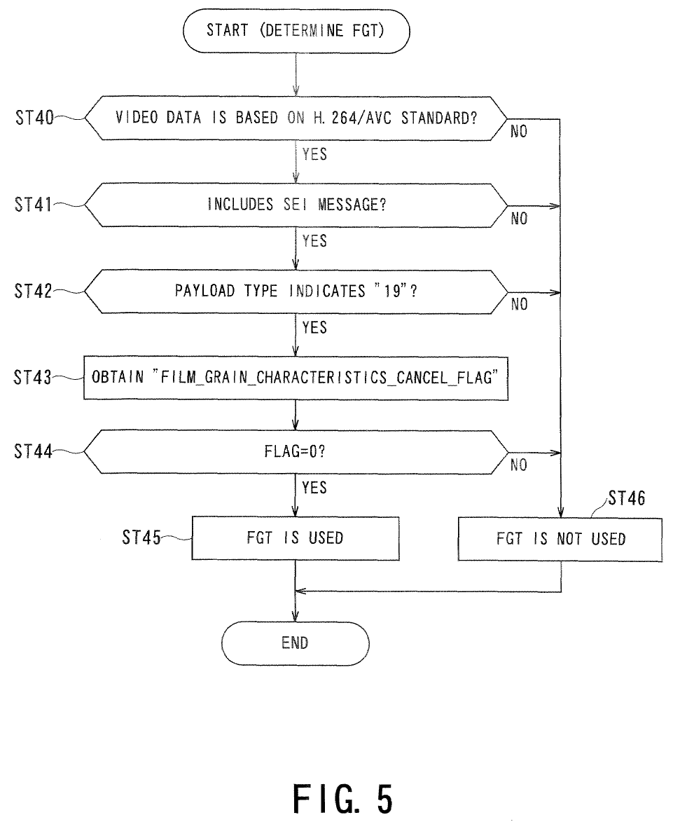

FIG. 5 is a flowchart showing the derails of one example of processing for determining whether or not the FGT is applied to the video data to be reproduced (FGT determination processing). The image management information is used to the determining processing.

First, in step ST40, it is determined whether or not the video data to be reproduced is based on the H.264/AVC standard. At the current time, only the H. 264/AVC standard uses the FGT and another standard and other standards, e.g., MPEG2 and VCl do not use the FGT. Then, when the video data is not based on the H.264/AVC standard (NO in step ST40), it is determined that “the FGT is not used” (in step ST46).

When the video data is based on the H.264/AVC standard, it is determined whether or not the image management information includes the SEI message (in step ST41).

All the video data based on the H.264/AVC standard does not include the SEI message. In the case of an optical disk based on an HD DVD standard, the video data necessarily includes the SEI message. However, in the case of an optical disk other than that based on the HD DVD standard, the video data does not necessarily include the SEI message. Then, even if the video data is based on the H-264/AVC standard, it is further determined whether or not the video data includes the SEI message.

If the video data does not include the SEI message, the FGT is not applied to the video data. Thus, it is determined that “the FGT is not used”.

If the video data includes the SEI message, subsequently, the content of the data “Payload Type” in the SEI message is monitored. In the case of the H.264/AVC standard, if the data “Payload Type” indicates “19”, it is prescribed that the FGT is applied to the video data. Therefore, even if the video data includes the SEI message, when the data “Payload Type” in the content of the SEI message does not indicate “19”, it is determined that “the FGT is not used”.

As mentioned above, the addition of the film grain with the FGT can be set on one frame unit of the image and this setting is performed with the “film_grain_characteristics_cancel_flag”. In step ST43, the FGT cancel flag is obtained from the SEI message. If the FGT cancel flag indicates “1”, it is determined that “the FGT is not used”.

On the other hand, if the FGT cancel flag indicates “0”, this means that “the addition of the film grain is not canceled” and it is finally determined that “the FGT is used” (in step ST45).

If it is determined that “the FGT is used”, the film gain adding unit 42 in the video decoding unit 40 adds the film grain to the image data, and the video image with the characteristics of the film grain is output from the video decoding unit 40.

Further, the video reproducing apparatus 1 has the noise reduction unit 50 that reduces noises. The noise reduction unit 50 is also referred to a DNR (Digital Noise Reducer). Hereinafter, the ON-operation of a noise reducing function of the noise reduction unit 50 is referred to as “DNR ON” (or noise-reduction ON) and the OFF-operation of the noise reducing function is referred to as “DNR OFF” (or noise-reduction OFF).

If the image data to which the FGT is applied is set to “DNR ON”, the film grain added with the FGT is reduced as noises, the effect of the film grain is reduced. Then, if “the FGT is used”, the control of the noise reduction is preferable to set “DNR OFF”.

On the other hand, “DNR ON” and “DNR OFF” depend on preferences of users to the image quality.

Then, in the control of the noise reduction (in step ST5 in FIG. 3), the film grain added with the FGT is used and the noise reduction function is selectively controlled in accordance with the preferences of users.

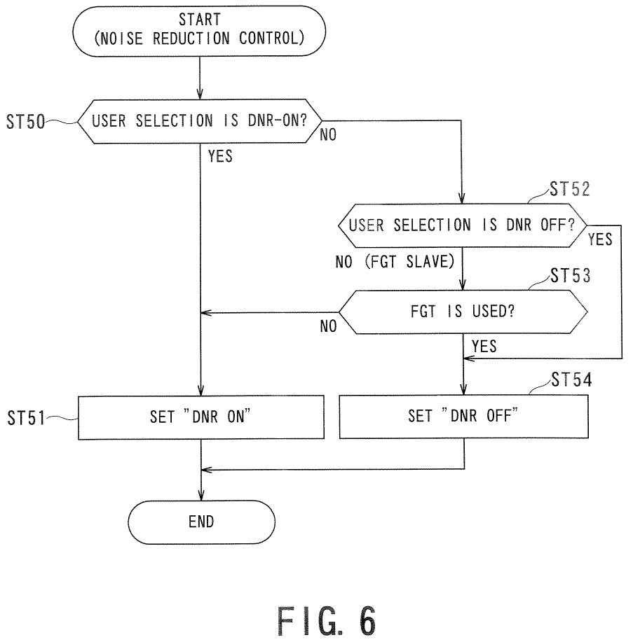

FIG. 6 is a flowchart showing the details of an example of control processing of the noise reduction. It is assumed that the user sets in advance a DNR mode (mode of the noise reduction function) in the control processing of the noise reduction.

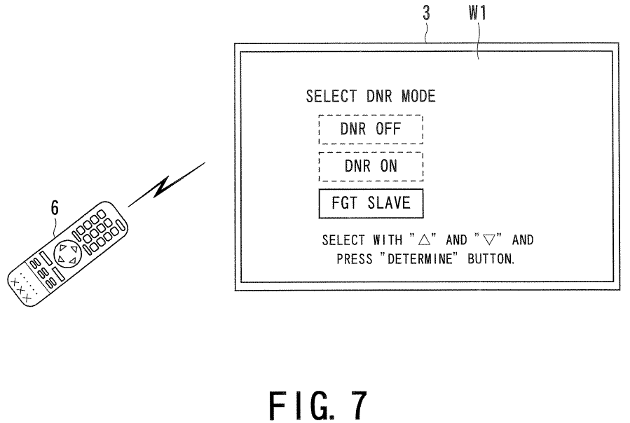

FIG. 7 is a diagram conceptually illustrating the setting situation of the DNR mode. The DNR mode includes a “DNR-ON mode” that always and forcedly sets the noise reduction function to ON, a “DNR-OFF mode” that always and forcedly sets the noise reduction function, and an “FGT-slave mode” that slaves the ON/OFF operation of the noise reduction function to the result indicating whether or not the FGT is used and sets the ON/OFF operation.

The three DNR modes are displayed, with a remote control device 6, on the video display unit 3 in the video reproducing apparatus 1. The remote control device 6 may allow the user to select the DNR mode so as to set any of the DNR modes. It is noted that the setting processing of the DNR mode is performed under the control with the remote control device 6 as the noise reduction settingl unit 62 and the MPU 60.

Referring to FIG. 6, in step ST50, it is determined whether or not the user selects the “DNR-ON mode”. Upon selecting the “DNR-ON mode”, the processing advances to step ST51 whereupon an instruction is issued to the noise reduction unit 50 so as to set the “DNR ON”.

In this case, the priority is given to the selection of the user irrespective of the use or no-use of the FGT, and the noise reduction function is set to ON.

In step ST52, it is determined whether or not the user selects the “DNR-OFF mode”. When it is determined that the “DNR-OFF mode” is selected, the processing advances to step ST54 whereupon an instruction is issued to the noise reduction unit 50 so as to set the “DNR OFF”.

Similarly in this case, the priority is given to the selection of the user irrespective of the use or no-use of the FGT, and the noise reduction function is set to OFF.

On the other hand, if it is determined that the user selects “the FGT slave mode” (NO in step ST52), the ON/OFF operation of the DNR is determined depending on the use or no-use of the FGT. That is, if “the FGT is used” (YES in step ST53), an instruction is issued to the noise reduction unit 50 so as to set the “DNR OFF”, thereby preventing the reduction of the characteristics of film grain. On the other hand, if “the FGT is not used” (NO in step ST53), an instruction is issued to the noise reduction unit 50 so as to set “the DNR ON”, and the noise reducing processing is performed similarly to that of the normal image.

As mentioned above, with the video reproducing apparatus 1 and video reproducing method according to the embodiments, the film grain added with the FGT can be effectively used and the noise reduction function can be selectively controlled in accordance with the preferences of users.

### (3) Other Embodiments

According to the embodiments, the ON/OFF operation of the noise reduction function is controlled in accordance with the DNR mode selected by the user.

Further, a function for controlling the addition of the film grain to the image data in accordance with the DNR mode selected by the user may be added. That is, when the user selects the “DNR-ON model”, it is determined that the user desires an image with low noises, and even if “the FGT is used”, a control signal for forcedly setting non-addition of “the film grain” is output from the noise reduction control unit 61 to the film gain adding unit 42.

With this function, when “DNR-ON” mode is selected, the film grain is not basically added. Therefore, it is possible to certainly provide an image with low noises (film grain).

Upon implementing the system structure shown in FIG. 2 using an actual hardware, this can be variously modified.

For example, the video decoding unit 40 may be realized by a micro processor (first micro processor), and the noise reduction control unit 61 and the noise reduction settingl unit 62 may be realized by the MPU 60 (second micro processor).

Further, the noise reduction control unit 61 may be realized by a microprocessor of the video decoding unit 40 (first micro processor). In this case, the control signal of the ON/OFF operation of the noise reduction of the noise reduction unit 50 is directly output from the video decoding unit 40.

In addition, the demultiplexer 20, the video decoding unit 40, the audio decoding unit 31, the noise reduction unit 50, the audio DAC 32, and the video DAC 51 may be structured as a one-chip system LSI and, moreover, the MPU 60 may be included in the system LSI.

The present invention is not limited to the embodiments and can be embodied by modifying the components without departing the essentials thereof in the actual stage. Further, the present invention can be structured by properly combining a plurality of components disclosed in the embodiments. For example, some components may be deleted from all the components according to the embodiments. Further, the components according to the different embodiments may be properly combined.

What is claimed is:

1. A video reproducing apparatus comprising:
a video decoding unit that decodes video data, determines, on the basis of image management information included in the video data, whether or not the video data is video data to which a film grain is to be added, and adds, when the video data is video data to which the film grain is to be added, the film grain to the video data to be decoded;
a noise reduction unit that reduces noises of the decoded video data; and
a noise reduction control unit that sets off the noise reduction function of the noise reduction unit when it is determined that the video data is video data to which the film grain is to be added.

2. The video reproducing apparatus according to claim 1, further comprising:
a noise reduction setting unit that sets ON/OFF operation of the noise reduction function in accordance with the user selection, and
wherein the noise reduction control unit sets the ON-operation of the noise reduction function, when the user sets the ON-operation of the noise reduction function and even if it is determined that the video data is video data to which the film grain is to be added.

3. The video reproducing apparatus according to claim 1, further comprising:
a noise reduction setting unit that sets ON/OFF operation of the noise reduction function in accordance with the user selection, and
wherein the video decoding unit does not add the film grain to the video data to be decoded, when the user sets the ON-operation of the noise reduction function and even if it is determined that the video data is video data to which the film grain is to be added.

4. The video reproducing apparatus according to claim 1, wherein the video decoding unit determines, every frame of the video data, whether or not the video data is video data to which the film grain is to be added.

5. The video reproducing apparatus according to claim 1, wherein the video data is video data based on ITU-T H. 264 standard,
the video decoding unit determines, when the video data includes an SEI message and a payload type included in the SEI message indicates “19”, that the video data is video data to which the film grain is to be added.

6. The video reproducing apparatus according to claim 1, wherein the function of the video decoding unit is realized by a first micro processor, and
the function of the noise reduction control unit is realized by a second micro processor.

7. The video reproducing apparatus according to claim 1, further comprising:
a video display unit that displays a video image.

8. A video reproducing method comprising the steps of:
(a) decoding video data, determining, on the basis of image management information included in the video data, whether or not the video data is video data to which a film grain is to be added, and adding, when the video data is video data to which the film grain is to be added, the film grain to the video data to be decoded;
(b) reducing noises of the decoded video data; and
(c) setting off the noise reduction function when it is determined that the video data is video data to which the film grain is to be added.

9. The video reproducing method according to claim 8, further comprising the step of:
(d) setting ON/OFF operation of the noise reduction function in accordance with the user selection, and
wherein, in step (c), the ON-operation of the noise reduction function is set, when the user sets the ON-operation of the noise reduction function and even if it is determined that the video data is video data to which the film grain is to be added.

10. The video reproducing method according to claim 8, further comprising the step of:
(d) setting ON/OFF operation of the noise reduction function in accordance with the user selection, and
wherein, in step (a), the film grain is not added to the video data to be decoded, when the user sets the ON-operation of the noise reduction function and even if it is determined that the video data is video data to which the film grain is to be added.

11. The video reproducing method according to claim 8, wherein, in step (a), every frame of the video data is determined, whether or not the video data is video data to which the film grain is to be added.

12. The video reproducing method according to claim 8, wherein the video data is video data based on ITU-T H. 264 standard, and
in step (a), when the video data includes an SEI message and a payload type included in the SEI message indicates “19”, it is determined that the video data is video data to which the film grain is to be added.

13. The video reproducing method according to claim 8, further comprising the step of:
displaying a video image.
